(19) United States
(12) Patent Application Publication
(10) Pub. No.: US 2007/0267506 A1
(43) Pub. Date: Nov. 22, 2007

(54) Data transaction card having a coil antenna with reduced footprint

(75) Inventors: Oded Bashan, Rosh Pina (IL); Itay Nehemya, Kfar Giladi (IL); Avner Rimon, Kfar Blum (IL)

Correspondence Address: BROWDY AND NEIMARK, P.L.L.C.;624 NINTH STREET, NW, SUITE 300, WASHINGTON, DC, 20001-5303, US

(73) Assignee: On Track Innovations Ltd., Rosh Pina (IL)

(21) Appl. No.: 11/603,012

(22) Filed: Nov. 22, 2006

(30) Foreign Application Priority Data
May 22, 2006 (IL) 175824

(51) Int. Cl. G06K 19/06

(52) U.S. Cl. 235/492

(57) ABSTRACT

A data transaction card having a substrate supporting a chip module coupled to opposite ends of a coil antenna wound so as to form a substantially integral number of main loops and having a supplementary loop having an active area that is different from an active area of the main loops. In one embodiment, the data transaction card has a substantially rectangular substrate having major and minor edges, which supports a substantially rectangular coil antenna having a major dimension that is substantially equal to a dimension of the major edge of the substrate. The coil antenna is positioned relative to the substrate so that a footprint of the coil antenna does not overlap an area of the substrate that is reserved for embossing data therein.

### FIELD OF THE INVENTION

This invention relates to data transaction cards with contactless interfaces.

### BACKGROUND OF THE INVENTION

Data transaction cards such as credit cards are configured to identify an authorized owner and account details to an automatic teller machine (ATM) and to this end are typically provided with a magnetic stripe in which this information is encoded. The magnetic stripe is formed on one surface of a plastic card on whose opposite surface there are embossed readable information such as the user's name, credit card number and expiry date. This information is required to ensure that the card is valid and to allow manual verification or checking that the card-holder is the rightful owner.

Credit cards of this kind have long been in use and they as well as the ATMs which read them are designed to international standards that ensure that a credit card conforming to the relevant standard will be readable in any standard ATM. It is therefore probably true to say that all credit cards and ATMs currently in use meet this Standard and any departure therefrom which would render a credit card no longer readable by an ATM is clearly highly undesirable.

One of the features of the Standard is the location of the embossing, which serves not only to allow the owner, for example, to read the pertinent details such as card number and expiry date but also allows transfer of this information together with the card-holder's name to a credit slip when the credit card is used to purchase goods. This is done by inserting the card face up in a manual press. A multi-leaved transaction slip having carbon paper inserts is then introduced so as to overlay the card, whereupon applying pressure to the transaction slip via a manual lever, transfers the details of the embossing to respective form fields of the credit slips via the carbon paper inserts.

The manual presses as well as the multi-leaved transaction slips that are used for this purpose all conform to the relevant Standard and are dimensioned not only for mutual compatibility but also must conform in all relevant respects to the dimensions of the credit cards. Specifically, the form fields of the credit slips must be both dimensioned and aligned to contain the appropriate embossed data. Consequently, the position of the embossing on the credit card is defined by the Standard and is not amenable to modification, since any tampering with the embossing of the card would cause mis-alignment with the respective data fields of the credit slips.

Although credit cards and credit slips as described above have long been in use, smart cards are a much more recent development and their application to bank transaction cards is still in its relative infancy. As is known, smart cards encode data not magnetically but rather store the data, possibly in encrypted format, in a chip memory within the card.

It is also known that communication with smart cards may be via either a contact pad or a contactless interface. The contact pad usually conforms to ISO 7816 and comprises Power, Clock, Reset and Data contacts that are configured to contact corresponding contacts in an ATM, so as to supply power from the ATM to the smart card and to allow data in the card memory to be read by the ATM. The contactless interface conforming to ISO 14443 comprises a coil antenna that is wound around the periphery of the card and is inductively coupled to a coil antenna connected to a card reader, so as to allow for power and data transfer between the card reader and the card.

A major problem regarding the production of contactless smart cards as credit cards is the proximity of the peripheral coil antenna of the card to the embossed data of the card. Specifically, their mutual proximity renders the coil susceptible to damage at the card production stage as the embossing process, almost the last stage of the card production, would damage any winding passing in the embossed area.

FIG. 1 shows schematically such a smart card 10 having a peripheral coil antenna 11 compliant with ISO/IEC 14443 that intersects embossed data 12 that is located in an embossing area 13 near a lower edge 14 of the smart card 10. It will be noted that the embossing area 13 actually spans nearly half the area of the card since it contains not only data near the lower edge of the card, typically relating to the card-holder's name, but also contains embossed data that relates to the card number and expiry date that is situated higher up, typically toward the center of the card.

Data transaction cards employing a contactless interface having a coil antenna of reduced footprint are known. By “reduced” footprint is meant that the effective area of the antenna coil is smaller than that of the conventional contactless smart card, which as noted above is very nearly equal to the complete area of the card.

US 2004/118930 (Beradi et al.) published Jun. 24, 2004 and entitled “Transparent transaction card” discloses a transparent credit card having a conventional magnetic stripe as well as a contactless interface comprising a coil antenna. FIGS. 15A and 15B thereof show an antenna coil of substantially rectangular shape having a reduced footprint so that it occupies a length substantially equal to that of the card and a height somewhat less than half the height of the card. In order that the coil does not interfere with the magnetic stripe, it is disposed toward an edge of the card that is farthest from the magnetic stripe. It is clear that this results in the antenna overlapping precisely that area where the card validity data is embossed.

U.S. Pat. No. 6,378,774 (Emori et al.) published Apr. 30, 2002 and entitled “IC module and smart card” addresses the need to avoid overlap between the coil and the embossing and to this end discloses an antenna coil disposed so as not to overlap an engagement portion for the IC module, defined as a region of an external terminal electrode serving as a contact-type electrode, an embossing region, or a magnetic stripe region. With reference to FIG. 1 of this reference, the problem is described by noting that at the lower part of the card, the distance between the embossing region and the periphery of the card takes a minimum value, i.e. 2.41 mm. If a multi-winding coil is formed from a point, which is 1 mm inside the edge of the card, toward the center of the card, with the pattern width and the pattern interval being set at 0.15 mm, the multi-winding coil can have five turns at maximum. Where the pattern width and the pattern interval are set at 0.1 mm, the coil can have seven turns at maximum. All this assumes total positioning accuracy of the embossing and the card cutting processes. With the given current technology limitations the above mentioned figures are not feasible and only one or two winding are safely practical.

It is essential for proper contactless operation that the card operates at the proper resonance frequency of the card, which is dictated by the antenna coil parameters and the chip input capacitance. Non-optimal resonance frequency would dramatically reduce the card operating range and would render the card incompatible with the ISO14443 and ISO10373-6 standards requirements. The resonance frequency of the card is also determined by the number of turns in the coil, and it is thus clear that attempting to locate the coil at the edge of the card without it fouling the embossed area, requires that the resulting width of the possible winding path, combined with the limited accuracy of the typical embossing versus winding placement process, may be so narrow that a maximum of one or two turns (if at all) can be accommodated in which case the proper resonance frequency of the card cannot be achieved. In order to achieve the proper resonance frequency of the card it is necessary to employ a larger number of turns (usually three or four) and, in such case, it is preferable not to dispose the coil at the outer peripheral portion of the card so as to avoid overlapping with the embossing region.

FIG. 5 of U.S. Pat. No. 6,378,744 shows a configuration where the antenna coil is wound outside of the embossing region and the contact area, such an arrangement being effective where the number of turns is ten or more. The IC module is surrounded by a coupler coil that allows for inductive coupling with an antenna coil. This imposes an additional limitation on the dimensions of the antenna coil since not only must it avoid overlapping the embossed region, but it also must avoid overlapping the contact area.

It is well known that the sensitivity of the antenna (its effectiveness in providing maximum operating range) is also a function of the coil's dimensions, the number of turns and the inter-turn spacing. The maximum sensitivity is usually achieved with maximizing the antenna coil area combined with the correct resonance frequency. This means that as the footprint of the coil is reduced so as to avoid fouling the embossing area of the card, so too is its sensitivity reduced. Thus, the solution to one problem gives rise to a different problem that severely impedes the card's operating range.

The exact calibration of the card's resonant frequency during manufacture is inherently difficult since the antenna coil's inductance is dependent on its dimensions, which are typically determined by the need to create the coil from an integral number of windings whose opposite ends are coupled to the chip module. This can be more easily seen with reference to FIG. 2 depicting a pictorial representation of the coil antenna 11 used in the smart card 10 shown in FIG. 1 when formed according to conventional methods. Thus, the smart card has a substrate supporting thereon a chip module 20, to which opposite ends of the antenna coil 11 are coupled and which is typically wound around a periphery of the substrate so as to form a substantially integral number of main loops 21.

Moreover, although the nominal operating frequency of the card is determined by the relevant Standard e.g. 13.56 MHz for ISO 14443, in practice the card resonance frequency may be different from this as determined by the specific chip and/or the specific application. In such case, it would clearly be preferable to manufacture the antenna coils of all cards based on a specific chip and/or intended for a specific application so that the resulting resonance frequency conforms to a specifically desired target frequency.

It should also be noted that any fine calibration that is done to the dimensions of the coil antenna during assembly is apt to be thrown out of calibration during the subsequent lamination of the card, owing to the high temperatures of the lamination process which cause certain shrinking of the coil geometry.

It is known in the art to provide capacitive means for adjusting the resonant frequency of a non-contact IC card antenna. For example, in JP2000331137A2 a main capacitor is connected to a plurality of tuning capacitors via fine wiring sections that may be selectively fused during manufacture so as to adjust the combined capacitance and hence the frequency of a resonant circuit including the capacitor and antenna coil. JP2002007985A2 discloses a non-contact IC card having an antenna coil provided on a card substrate, and a resonance frequency adjusting unit provided at a leading edge of the antenna coil and comprising capacitor patterns formed on the substrate and overlapping a conducting layer.

Capacitive elements are formed of metal plates that are practically unacceptable in PVC cards owing to the problematic production technique and the associated costs.

It is also known to effect fine tuning adjustment of the antenna coil's resonant frequency by altering the inter-winding spacing. This approach has limited adjustment range, particularly when available winding space is not wide enough to effect the required interspacing, as may be the case when the antenna coil is wound around the card periphery, between the embossed area and the edge of the card, or in the case of the antenna coil routed between a narrow space between two embossed areas.

It would therefore be desirable to provide a smart card that serves as a data transaction card, and specifically a credit card bearing embossed data in a conventional embossing area, that has a contactless interface with a single coil antenna of sufficiently large footprint to permit most efficient coupling with the reader antenna, without fouling the embossing area.

It would also be preferable that such a smart card have higher sensitivity than hitherto-proposed configurations having coil antennas of reduced footprint.

Moreover, it would be desirable to provide such a smart card so that the resonance frequency of the antenna coil is adjustable, without the need to provide means for adjusting tuning capacitors while utilizing the maximum available area on the card for the antenna coil.

### SUMMARY OF THE INVENTION

It is therefore an object of the invention to provide a smart card that serves as a data transaction card having a coil antenna, whose resonance frequency is continuously adjustable during manufacture, to basically any desired resonance frequency, utilizing a desired portion of the card.

It is a further object to achieve such adjustment without requiring problematic spacing between the windings and/or tuning capacitors.

It is a further object of the invention to provide such a smart card that serves as a credit card bearing embossed data in a conventional embossing area, and that has a contactless interface with a single coil antenna of sufficiently large footprint to permit more efficient coupling with the reader antenna, without fouling the embossing area.

These objects are realized in accordance with the invention by a data transaction card having a substrate supporting a chip module coupled to opposite ends of a coil antenna wound so as to form a substantially integral number of main loops and having a supplementary loop having an active area that is different from an active area of the main loops.

Most typically, the supplementary loop is of smaller active area than the main loop. If it were in fact larger than the main loop, then it would be equally possible to achieve the equivalent effect by winding the main loop with one extra turn and to apply the necessary fine tuning using a smaller supplementary loop. In either case, it will be recalled that the more turns in the main loop, the lower will be the resulting resonance frequency. Therefore, during manufacture it is easier to add turns to the main loop until the measured resonance frequency is too low, and then to remove one turn and add the supplementary loop so that its inductance aids that of the main loop and of appropriate dimensions to achieve the desired resonance frequency.

However, it also possible to wind the main loop until the measured resonance frequency is too low and then to achieve the necessary adjustment by winding the supplementary loop so that its magnetic flux basically opposes that of the main loops. This reduces the overall inductance of the coil and thus raises its resonance frequency. Of course, this uses more wire than minimally necessary and so is a less preferred solution.

It also feasible to remove not just one turn but two complete turns (so that the measured resonance frequency is too high) and then achieve the necessary adjustment by winding a bigger supplementary loop so that its magnetic flux basically aids that of the main loop and so as to have a higher active area. This uses less wire than the preferred approach but at the expense of increasing the overall area of the coil.

It will be appreciated that extent of the adjustment achieved by the supplementary loop is empirical rather than theoretical. The actual adjustment depends on a lot of factors many of which combine so as to render impractical quantitative prediction or calculation of the required dimensions and location of the supplementary loop. These factors include location of the supplementary loop relative to the main loop, winding area and geometry. The invention resides principally in the use of a supplementary loop to allow fine adjustment of the resonance frequency, it being understood that the actual design of the supplementary loop for obtaining maximum mutual coupling is not within the scope of the patent. For the purpose of carrying out the invention it is sufficient to decide on a suitable geometry, based for example on available space, and to adjust the dimensions of the supplementary loop by trial and error until the measured resonance frequency is correct or until optimal performance is achieved.

In one embodiment, the data transaction card has a substantially rectangular substrate having major and minor edges, which substrate supports a substantially rectangular coil antenna having a major dimension that is substantially equal to a dimension of the major edge of the substrate and which is positioned relative to the substrate so that a footprint of the coil antenna does not overlap an area of the substrate that is reserved for embossing data therein.

Thus, unlike hitherto-proposed IC data transaction cards, the data transaction card according to the invention proposes a coil antenna that has a long side substantially equal to the length of the card, while nevertheless being located well clear of the embossing area. Preferably, the coil antenna has a short side substantially equal to about half the height of the card such that maximum area of the coil antenna is realized within the limitations set by the need to avoid overlapping the embossing area.

### BRIEF DESCRIPTION OF THE DRAWINGS

In order to understand the invention and to see how it may be carried out in practice, some embodiments will now be described, by way of non-limiting example only, with reference to the accompanying drawings, in which:

FIG. 1 is schematic representation of a prior art contactless smart card dimension compliant with ISO/IEC 14443;

FIG. 2 is a pictorial representation of a prior art coil antenna for use in the smart card shown in FIG. 1;

FIGS. 3a, 3b and 3c are pictorial representations of coil antennas wound according to alternative embodiments of the invention;

FIGS. 4a and 4b are schematic representations of a smart card having a coil antenna according to the invention of reduced dimension that is located so as to avoid fouling embossing areas; and

FIG. 5 is a flow diagram showing how a coil antenna according to the invention is calibrated to a desired tuned frequency during manufacture.

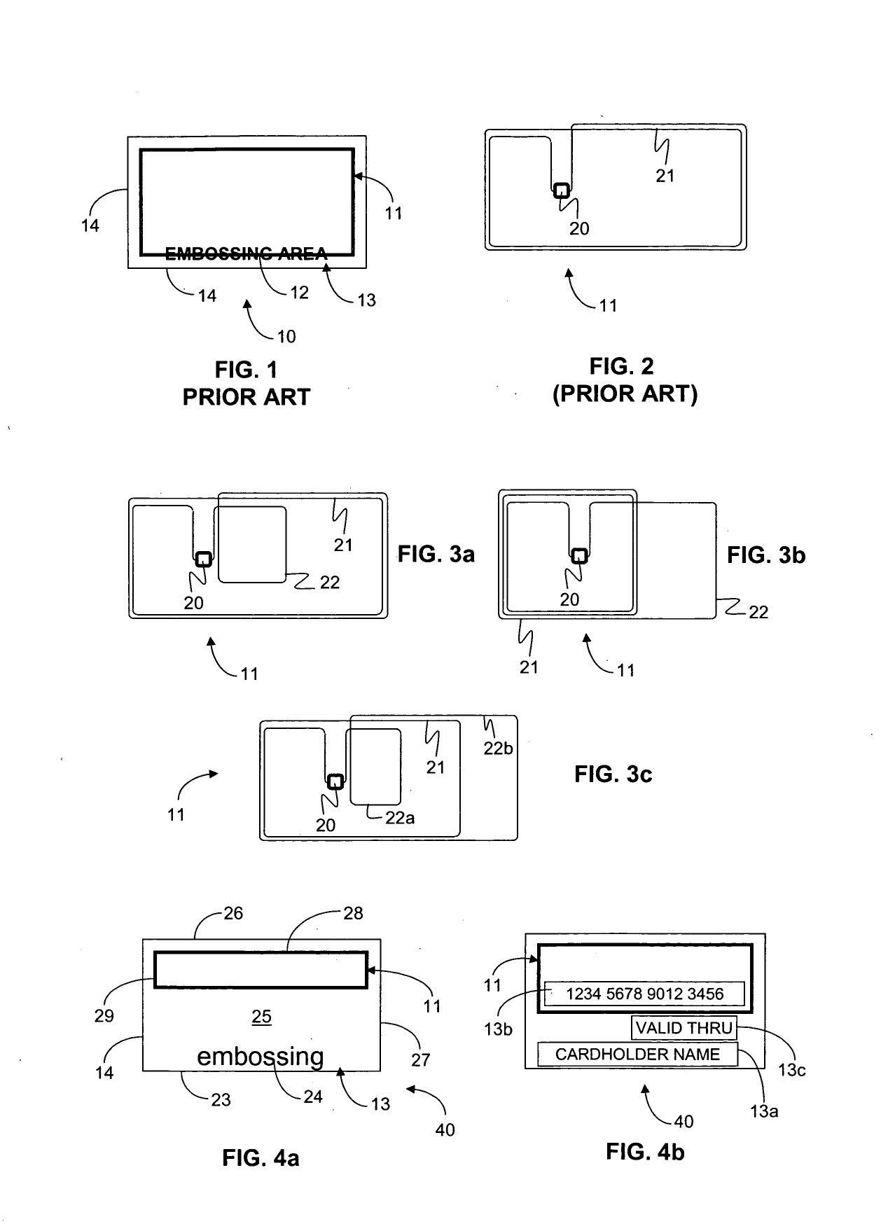

### DETAILED DESCRIPTION OF EMBODIMENTS

In the following detailed description of some embodiments, identical reference numerals are used in different figures to refer to components that are identical or serve the same or similar function.

FIGS. 3a and 3b are pictorial representations of coil antennas 11 wound according to alternative embodiments of the invention. Thus, both figures show a chip module 20 mounted on a substrate and coupled to opposite ends of the coil antenna 11, which is wound so as to form a substantially integral number of main loops 21 and having a supplementary loop 22 that is dimensioned so that an overall active area of the coil antenna is different than that of a single main loop.

As shown in FIG. 3a, the supplementary loop 22 is internal to the main loops 21. Alternatively, the supplementary loop 22 may be external to the main loops 21 as shown in FIG. 3b. According to yet another embodiment shown in FIG. 3c, the main loops 21 are of a length that is less than that of the card and the supplementary loop 22 comprises a first part 22a that is internal to the main loops 21 and a second part 22b that is external to the main loops 21.

FIG. 4a shows schematically a data transaction card 40 (also known in the art as a contactless smart card) according to an embodiment of the invention having a coil antenna 11 of substantially rectangular form that is located so as to avoid intersecting an embossing area 13 that is located in near a lower edge 23 of the data transaction card 20 for containing embossed data 24. Again, it is to be noted that the embossing area 13 actually spans about half the area of the card since it contains not only data 24 near the lower edge of the card, typically relating to the card-holder's name, but also contains embossed data that relates to the card number and expiry date that is situated higher up, typically toward the center of the card.

It is generally required to maximize the area of the main loop without risking fouling with the embossing area or getting too close to the edges of the card. In practice, cards may be mass-produced on a single inlay, and sufficient border must be left between the coil and the periphery of each card in order to cater for the low accuracy associated with the final cutting of the inlay to separate the individual cards.

In accordance with one non-limiting embodiment of the invention, the data transaction card 20 has a substantially rectangular substrate 25 having major and minor edges 26 and 27, respectively. The coil antenna 11 has a long side 28 having a dimension (constituting a major dimension) that is substantially equal to a dimension of the major edge of the substrate. The coil antenna 11 has a short side 29 having a dimension (constituting a minor dimension) that is preferably substantially half a length of the minor edge of the substrate so as to allow the coil antenna 11 to be positioned relative to the substrate 25 so that a footprint of the coil antenna 11 does not overlap the embossing area 13 while maximizing the footprint of the coil antenna. Preferably, the coil antenna 11 is wound around a partial periphery of the substrate 25 so that the long side 28 of the coil antenna is proximate the major edge 26 of the substrate remote from the embossing area 23.

In the embodiment shown in FIG. 4a, the coil 11 is kept clear of the complete area of the substrate containing embossed data, this whole area thus constituting the embossed area 13. FIG. 4b shows an alternative configuration where the embossed area 13 is divided into three embossed areas shown as 13a, 13b and 13c for displaying cardholder name, card number and expiry date, respectively. In such an embodiment, the coil 11 is preferably dimensioned so that its upper edge is proximate the upper edge of the substrate and its lower edge is between the areas 13b and 13c. This results in the coil antenna 11 having a somewhat larger footprint than that shown in FIG. 4a.

The coil antenna 11 is formed in a manner as described above with reference to FIGS. 3a, 3b and 3c of the drawings and connected directly to the IC module 20 without the need for intermediate coupling coils.

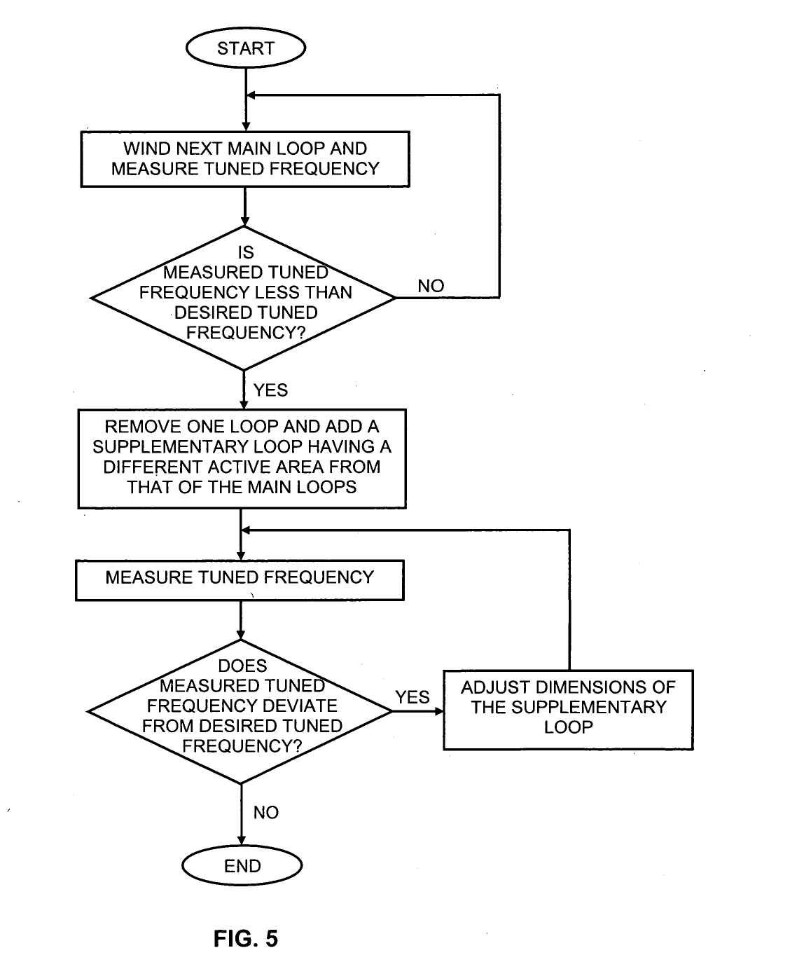

FIG. 5 is a flow diagram showing how the coil antenna 11 according to the invention is calibrated to a desired tuned frequency during manufacture. The coil antenna 11 is wound so as to form a substantially integral number of main loops 21. The tuned frequency of the coil antenna 11 is measured and additional complete loops are wound until the measured tuned frequency is less the desired resonance frequency. The last loop is now removed, and one additional loop which is wound to form a supplementary loop 22 as shown in FIGS. 3a, 3b or 3c. The tuned frequency of the coil antenna 11 is then measured, and if the measured frequency deviates from the desired resonance frequency, the dimensions of the supplementary loop 22 are adjusted until the measured frequency equals the desired resonance frequency. In accordance with one embodiment, the substrate 25 is laminated prior to measuring the tuned frequency of the coil antenna 11. This is done since, as noted above, the high temperatures of the lamination process may cause slight shrinkage of the coil, thus de-tuning the coil. It is therefore preferable to check the effect of any adjustments to the dimensions of the supplementary loop after lamination, and to repeat the process by trial and error until a card is produced whose tuned frequency is correct. Once this is done, the dimensions of the coil may be replicated in respect of all further cards, which may be laminated so as to produce data transaction cards that are reliably tuned to the desired frequency.

It will be appreciated that modifications may be made without departing from the scope of the invention as claimed in the appended claims. For example, while the coil antenna has been described as having a rectangular form, it will be appreciated that this is not a requirement and the principles of the invention may be applied to other coil geometries, for example, circular or other shapes.

1. A data transaction card having a substrate supporting a chip module coupled to opposite ends of a coil antenna wound so as to form a substantially integral number of main loops and having a supplementary loop having an active area that is different from an active area of the main loops.

2. The data transaction card according to claim 1, wherein the supplementary loop is internal to the main loops.

3. The data transaction card according to claim 1, wherein the supplementary loop is external to the main loops.

4. The data transaction card according to claim 1, wherein the supplementary loop is both internal and external to the main loops.

5. The data transaction card according to claim 1, wherein the active area of the supplementary loop is smaller than the active area of the main loop.

6. The data transaction card according to claim 1, wherein the active area of the supplementary loop is larger than the active area of the main loop.

7. The data transaction card according to claim 1, wherein:
the substrate is substantially rectangular having major and minor edges, and
the main loops of the coil antenna are substantially rectangular having a major dimension that is substantially equal to a dimension of the major edge of the substrate, and are positioned relative to said substrate so that a footprint of the coil antenna does not overlap an area of the substrate that is reserved for embossing data therein.

8. The data transaction card according to claim 7, wherein the main loops of the coil antenna are wound around a partial periphery of the substrate so that a long side of the coil antenna is proximate the major edge of the substrate.

9. The data transaction card according to claim 7, wherein a minor dimension of the coil antenna is about half the length of the minor edge of the substrate.

10. The data transaction card according to claim 7, wherein the card bears embossed data depicting card number and expiry date and the coil is dimensioned so that an upper edge thereof is proximate an upper edge of the substrate and a lower edge thereof is between the areas of the substrate on which the card number and expiry date are embossed.

11. A method for producing a data transaction card having a substrate supporting a chip module coupled to opposite ends of a coil antenna tuned to a predetermined frequency, the method comprising:
winding the coil antenna so as to form a substantially integral number of main loops;
winding one of the main loops to form a supplementary loop having an active area that is of different from an active area of the main loops;
measuring a tuned frequency of the coil antenna; and
if the measured frequency deviates from said predetermined frequency, adjusting the dimensions of the supplementary loop until the measured frequency equals the predetermined frequency.

12. The method according to claim 11, further including laminating the substrate prior to measuring the tuned frequency of the coil antenna and wherein any adjustments to the dimensions of the supplementary loop are made in respect of the effect of the lamination process.
